(19) United States
(12) Patent Application Publication
(10) Pub. No.: US 2020/0066076 A1
(43) Pub. Date: Feb. 27, 2020

(54) Remote Consensus Control System

(71) Applicants: Nelson Correia Abreu, Los Angeles, CA (US); Mohammadreza Bashiri, Rancho Palos Verdes, CA (US)

(72) Inventors: Nelson Correia Abreu, Los Angeles, CA (US); Mohammadreza Bashiri, Rancho Palos Verdes, CA (US)

(21) Appl. No.: 16/546,637

(22) Filed: Aug. 21, 2019

Related U.S. Application Data
(60) Provisional application No. 62/722,597, filed on Aug. 24, 2018.

(51) Int. Cl. G07C 9/00

(52) U.S. Cl. CPC G07C 9/00182

(57) ABSTRACT

A Remote Consensus Control System (RCCS) allows authorized users to operate a device at a distance with consensus logic. One or more users can remotely apply a locking command. The device will remain locked until the very last user consents to unlocking. Any application requiring unanimous consent could use a RCCS to drive a mechanical lock, status indication, or a digital control or indication signal. The signal can drive a human-machine interface (HMI) or send a permissive signal, message, or command to open or initiate, close or terminate, or otherwise modify the state of a system or process. The RCCS is comprised of a logic system residing in a networked computing system. The logic system receives instructions from users (via mobile, web or text message), and issues responses to the users and commands to a set of binary outputs for each RCCS field device.

### BACKGROUND OF THE INVENTION

### 1. Field of the Invention

This invention relates to the lockout-tagout (LOTO) systems utilized for industrial electrical safety as well as remotely controlled switches, such as door locks and padlocks that may be operated via mobile apps.

### 2. Description of Prior Art

Lockout tagout (LOTO) systems that may use tags, locks, lockboxes, and/or hasps are widely used in the electrical industry. The LOTO technique allows crew members to prevent closing of equipment and the introduction of hazardous energy or conditions without their permission. Circuits and equipment they are working on can only be operated or re-energized after they provide consent by removing their lock. However, when crews are working in different locations, the industry lacks a system to perform a similar “LOTO” function. This has resulted in injuries and fatalities when communication (usually via radio) breaks down and equipment is operated before all crews are in the clear.

There are also switches and locks that may be operated remotely via Supervisory Control and Data Acquisition (SCADA), Remote Terminal Units (RTU), and wired or wireless communication systems, with or without the use of web or mobile interfaces. Examples include operating garage doors or house doors and electrical equipment from a distance. However, there are no systems customized for consensual operation, whereby equipment remains closed until all authorized parties consent to the operation: this could be opening a safe, closing an electrical switch, or activating a green LED light or receive a message that signals a team to initiate an action that required consensus of various authorization parties.

There are many control systems, including remote control systems (e.g. U.S. Pat. No. 6,043,753), wireless lock systems (e.g. U.S. Pat. Nos. 9,679,429, 6,967,562, 9,787,127, 9,530,295, 7,624,280, 9,406,180), among them. Existing LOTO systems (e.g. CN102736548B, U.S. Pat. No. 8,688,247B2, WO2018007070A1, U.S. Pat. No. 8,643,225, US20140176303) can be considered consensual control system, albeit local or mechanical control systems. However, there remains a lack of remote and consensual control systems to fill needs such as LOTO over long distances or remote consensus safes or remote consensus door/gate locks. This need led to the development of the present patent for such useful applications as the aforementioned.

The gap left by prior art is evidenced by related accidents, misoperations, injuries and fatalities which could be prevented by the use of an RCCS, but that continue to take place due to the unavailability of such a solution. When the source of hazard is distant, LOTO is not practical, so workers rely on radio communications (e.g. walkie-talkies) which leaves workers vulnerable to miscommunication, radios being turned off, dead battery, or low volume. RCCS could save lives in such cases by not allowing hazardous energy to be re-introduced without the express consent of every last worker that originally applied a “digital lock” at a distance.

This non-provisional application is the follow up to provisional application 62/722,597 filed Aug. 24, 2018.

### BRIEF SUMMARY OF THE INVENTION

A Remote Consensus Control System (RCCS) allows a single authorized user to either lock or unlock a device. Subsequent users may reinforce that action by applying their own commands. The system will not change state until all users consent to it. The RCCS is useful for applications that require consensual permission of multiple parties for an operation (only open, only close, or only send a signal or message when all parties agree). One important example is related to the electrical industry's “lockout tagout” (LOTO) process, whereby workers are able to apply a tag and a lock to prevent a circuit from being turned on. This process saves numerous lives when used properly, by preventing equipment from being re-energized without a worker's knowledge and permission. Systems employing lockboxes and other accessories work well when workers apply their own physical tags and locks. However, every year, workers are injured or killed in situations where they are geographically spread out, such that a physical LOTO system is impractical.

A Remote Consensus Control System (RCCS) addresses this need by allowing multiple remote workers to control a single physical switch at a distance that may be managed by a crew leader. A RCCS may augment coordination via voice communications, which is many crews rely on. When radio communication is used by itself, however, there is a safety vulnerability. Specifically, there have been cases when a radio warning was issued to crews, but some did not hear the warning due to radios being silenced or in a low volume or low power. This has resulted in equipment being re-energized while crews were handling it, causing injury or fatality. A RCCS would allow workers to apply a logic-based or digital lock remotely. The crew leader would then know if one or more workers has not completed their work. The crew leader would know when all workers have removed their respective locks, mutually consenting to the re-energization of the circuit or equipment, signaling to the crew leader all personnel is “in the clear.”

Any application requiring unanimous consent could use a RCCS to drive a mechanical lock, status lights (i.e. green/red indication), or a digital control or indication signal for a human-machine interface (HMI) or for the sending of a permissive signal, message, or command to open or initiate, close or terminate, or otherwise modify the state of a system or process. Examples include a safe that remains locked until all parties agree to open it using a RCCS; a permissive indication sent via RCCS that demonstrates that all parties have authorized an action or completed required prerequisite steps; or a permissive signal to operate equipment (open or close, turn on or off) after all parties have agreed via a RCCS.

The RCCS allows multiple individuals to remotely control a switch such that one or more authorized users may issue a change of state operation (for instance, a lock or close command). Successive individuals can apply their own digital commands to re-enforce the original command. The digital output remains in the same state (e.g. locked) until the last user undos the original command (e.g. by all sending an unlock instruction). As such, any one authorized user may operate the digital output (e.g. lock a switch), but it requires total consensus for all authorized users to reverse the status of the digital output (e.g. allow the lock to be opened). Any application that requires such mutual consensus for changing the status of a device or system remotely, may benefit from this remote consensus control system to operate a consensual digital output that may drive a variety of systems.

In the distributed “lockout tagout” application, when it is impractical for workers to each apply their own physical lock to an energy source, workers can remotely operate a RCCS to operate a digital output that drives a lock or, at a minimum, a status indication that is managed by the crew leader. Each worker will apply and remove a virtual, digital lock and receive SMS text message confirmation each time there is a change in users or lock status. As long as at least one individual remains with an outstanding applied virtual lock command, the RCCS remains in the lock position. These commands and status updates may be issued via a phone call, an app, website interface, or any other practical means.

The digital output-driven lock can be applied to a standard lock box that contains a unique key that can close and energize a circuit. Anyone working on this circuit that is unable to apply a physical lock may now do so by controlling a RCCS. Multiple remote workers can control a single RCCS, each applying a virtual lock. The RCCS ensures the lock is open when no one has applied a virtual close command. In this potentially life-saving application of the RCCS, as long as one or more workers have applied their lock command, the lock remains closed. Alternatively, an instruction to proceed will only be issued when all authorizing parties assent to it. In another application, a safe will only be unlocked by the RCCS digital output when all authorizing partners signal their agreement.

The RCCS is comprised of a logic system residing in a networked computing system (e.g. server, mobile phone, cloud computing). The logic system receives instructions from users (via mobile, web or text message, for example) and issues responses to the users and commands to a set of binary outputs (an “a” or normally open and a “b” or normally closed contact) for each RCCS field device. The novelty of the RCCS resides in this logic, whereas the systems for storing the logic, communicating with logic and the control hardware are all available “off the shelf” and already exist in the market.

There are various ways to incorporate the RCCS, but the preferred embodiment will be described herein. The hardware can include off-the-shelf remote terminal unit (“RTU”) such as those used to operate garage door openers or the doors of shipping containers. Some of these units change state when they receive a text message. However, they do not handle the consensus switch logic. With the RCCS logic mediating between users (communicating via text, call, web, mobile or other remote interface) and the RTU, it can be ensured that the digital outputs operate in accordance to the desired consensual logic. The dry “a” or “b” contacts off the RTU can then be wired to a wide variety of output indication or control options, depending on the application.

With the use of a wetting control voltage provided by an off-the-shelf AC-to-DC rectifier (power supply), a battery source, or an AC source, the contacts can either close or open a control or indication path according to the RCCS logic. These contacts can drive switches, relays or other common control or indication systems, such that it only takes one or more authorized user to closes the “a” contact (and open the “b” contact) when they apply their “digital lock.” The “a” contact opens (and the “b” contact closes) when all authorized users who applied locks have removed them.

### BRIEF DESCRIPTION OF THE DRAWINGS

Depending on the application, users can call a phone number or login to an app or website on their mobile communication device to contact the RCCS. FIGS. 1.1, 1.2 and 1.3 present a set of logical flowcharts that illustrate a preferred logically embodiment of the RCCS using SMS text message communication.

FIG. 2.1 shows preferred embodiments of the system architecture, relating the consensual logic system or Logic Engine (LE) to the field device or Mobile Controller (MC) or lock. FIG. 2.2 shows how the physical components can come together using an off-the-shelf garage door opener (a preferred physical embodiment), and FIG. 2.3 shows a rendering of the RCCS as an integrated lock for locking applications (the most preferred physical embodiment).

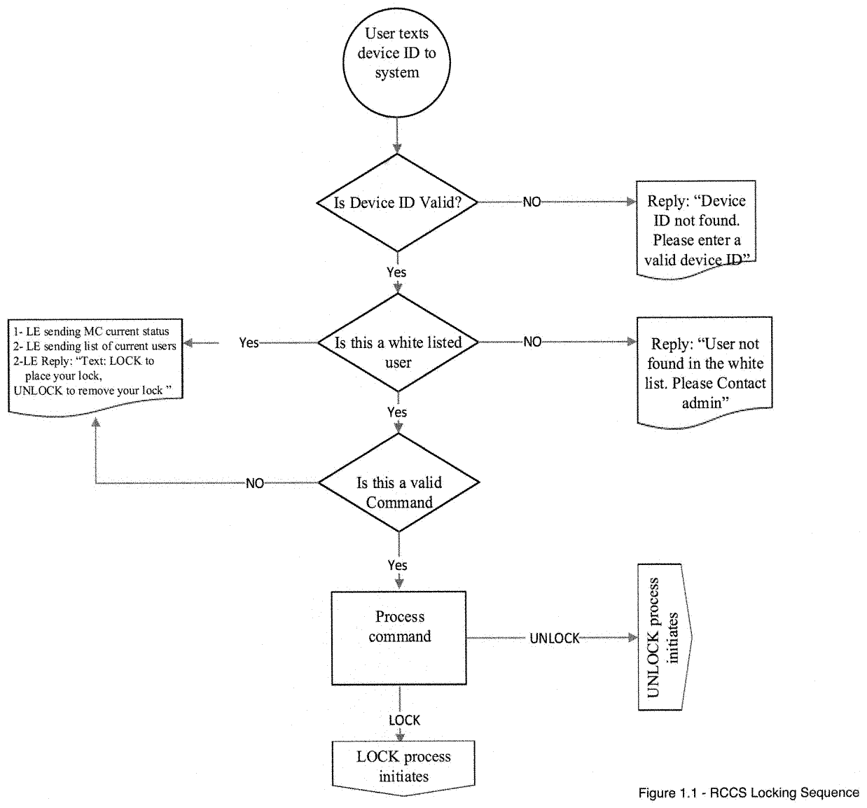

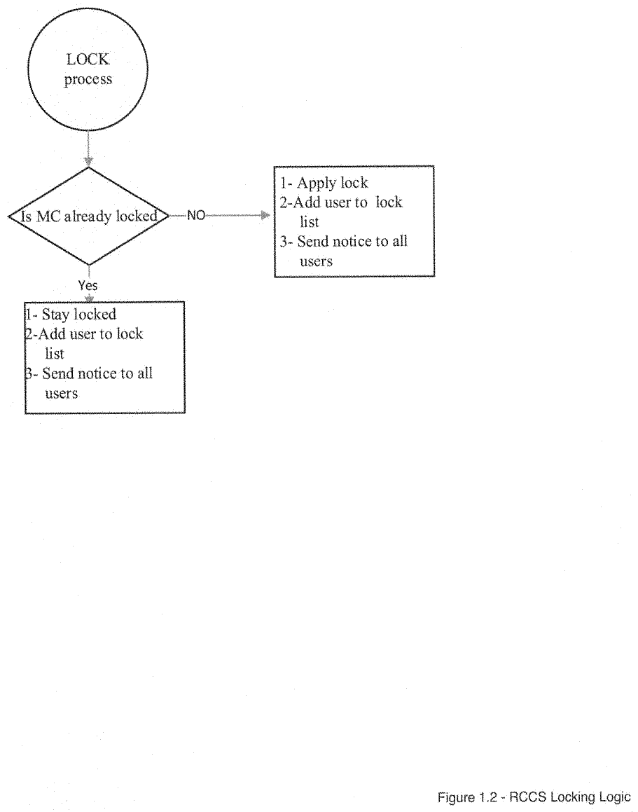

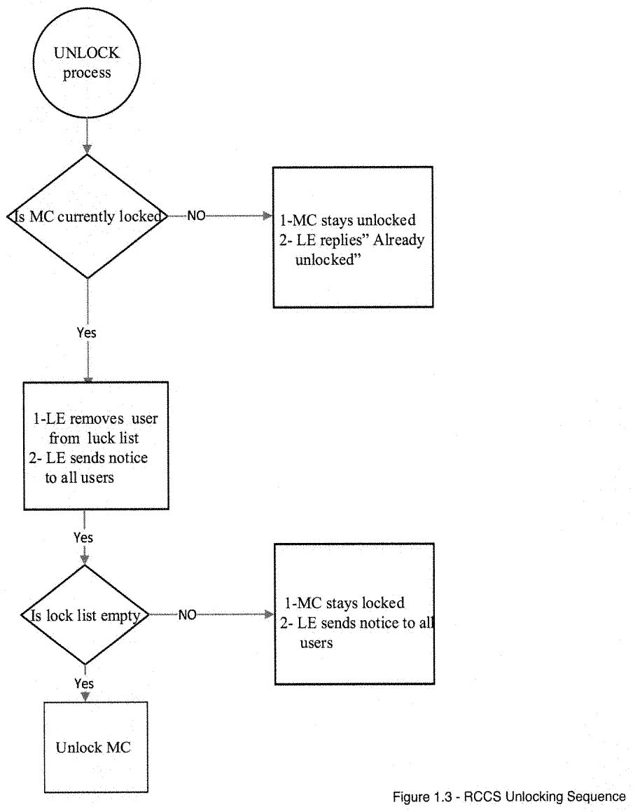

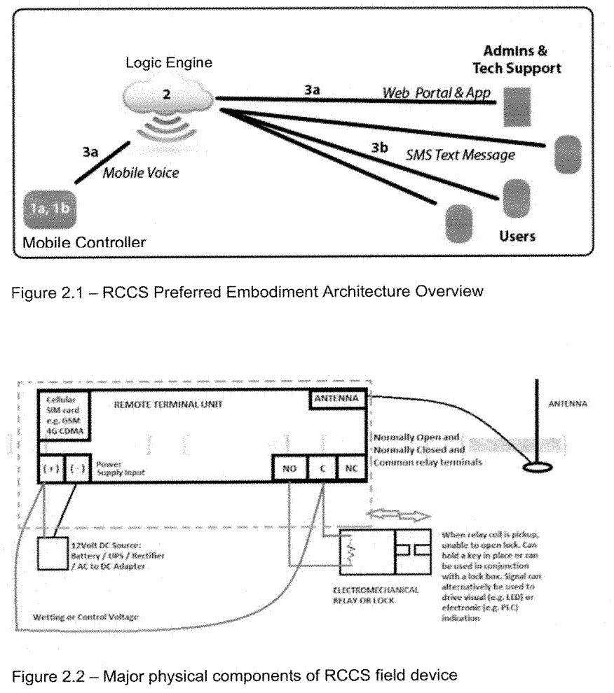

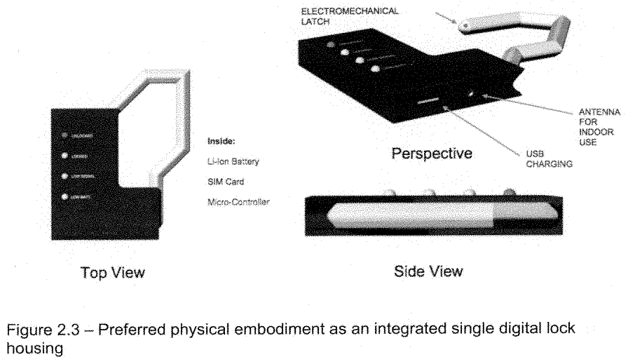

### DETAILED DESCRIPTION AND BEST MODE OF IMPLEMENTATION

In the Preferred Embodiment of the Invention, referring to the configuration depicted in FIG. 1.1, remote users (mobile numbers) interface with Mobile Controller (MS)—the digital output hardware that can send open/close status or controls—via the Logic Engine (LE)—the logical system at the heart of the RCCS. Users interface with the LE using SMS text messages to account for limited mobile reception conditions. The LE toggles the digital outputs of the MS via calls to the MS's mobile-enabled remote terminal unit component, outfitted with a mobile carrier's SIM card and an antenna. The digital outputs are wired to the desired indication and/or control circuit. Referring to FIG. 1.2, a DC power supply provides control wetting voltage to open or close a DC relay that acts as a lock and indication.

Users can add or remove a “digital lock” (add or remove themselves from the Lock List) by texting the RCCS's LE. When the Lock List managed by the LE is empty, the LE makes sure the MS's digital outputs are in the de-energized position (“a” contact is open, “b” contact is closed). When there is one or more user in the Lock List, the digital outputs are in the energized position (“a” contact is closed, “b” contact is open), thereby operating the MS in a consensual manner, thanks to the LE.

Users send a text message to the RCCS system phone number with the MC ID number. The option to require user phone numbers to be added to a whitelist of authorized users is available, via an administrative console. The LE associates the user to the MC or, if the option is enabled, checks whether the phone number being used has been whitelisted for the device in question. The MC ID number may also be automatically recognized if it the number texted to is a unique phone number associated with the MC ID in question. If the MC ID and user are valid, the LE updates the user with the current status of the MC, the current list of users in the Lock List and awaits for Lock or Unlock commands. LE sends close signal to the respective MS when the first user applies a lock to the MS via the RCCS's LE (joins the Lock List for the particular field device). The RCCS then informs all users in the lock list about the current status of the MS, current users, and command options. The LE will issue an open command when the last user removes his or her digital lock for a given MS. Each time the LE changes the status for a particular user, it will issue a confirmation (via either SMS text message, web or app status) confirming to all remaining parties that the user digital lock has been applied or removed. Each time the MS changes its status, it reports the status to the LE system and finally the app will issue a message to all current users associated with the particular MS ID.

Each MS has a unique phone number alias assigned to it and it operates by in a toggle fashion by receiving a phone call from an authorized (whitelisted) phone number. This would be the phone number of the LE. The role of the RCCS application (LE) is to determine which state the lock should be in by managing user commands. The MS will have normally-open and normally-closed contacts, allowing for consensual locking or unlocking, open or closed control, go or no-go indication depending on the application. Note that the Logic Engine may reside in a microprocessor housed in the field unit instead of “in the cloud” or other off-device computing service.

The RCCS Logic Engine (LE) running on the cloud (alternatively, on a server) and accessed via SMS text message (and a web-based administrative console for backend management, such as user whitelist management and dealing with cases of lost, powered down or damaged phones), maintains a matrix of locks owned by a given organization. These may be added by the admin user. Any changes to a lock and current list of users are notified to all current users. For illustrative purposes of a preferred embodiment of the Logic Controller programming, in a particular case, LockMatrix=[Lock_1, 13103217654; Lock_2, 13057771111; . . . ].

There is a UserMatrix for each Lock:

Lock1_UserMatrix=[initial state is empty, no current users]
Lock2_UserMatrix=[initial state is empty, no current users] etc
When the first user (“user1”) texts the phone number on the lock provided by the crew leader, the SMS will be sent to the LE. The app will determined who called and which lock is being referred based on the text message and the MC ID's in the LockMatrix.

For illustration purposes, consider the Use Case: text is received from phone number 7861234567 at the alias 13057771111. LockID routine looks for 13057771111 in LockMatrix. If not found, look up Device ID in the text message. If neither is found, return message “Lock not Recognized.” Contact Admin.” If lock is identified (“Lock_1”), CheckUser is valid if there is a white list and prompt for command. The routine verifies if the user is already in the Lock1_UserMatrix and prompts for a command. If Lock1_UserMatrix=[blank] or 13057771111 is not in Lock1_UserMatrix and user applies lock, Add 13057771111 to Lock1_UserMatrix and reply to user “Lock Applied.” Text the list of users currently listed under Lock1_UserMatrix to all users. Else remove 13057771111 from Lock1_UserMatrix Lock1_UserMatrix and reply “Lock Removed” and text the list of users currently listed under Lock1_UserMatrix to all users or simply “No Current Users” to this latest user. If Lock1_UserMatrix is blank issue OPEN command and receive confirmation of open status else issue CLOSE command and receive confirmation of closed status.

If a user no longer has access to the phone used to apply the virtual lock, a system administrator can remove it via the admin console.

Any application requiring unanimous consent could use a RCCS to drive: a mechanical lock; status lights; or a digital signal, for instance. A light indication can change from glowing red to green to indicate to others that all applicable parties have authorized an action or completed required prerequisite steps. An electrical contact can block a control or indication signal until consensus is reached. A lock can be applied to a safe so that it can only be opened with unanimous consent. In all cases, each relevant permission can only be sent from pertinent phone numbers.

What is claimed is:

1. A remote consensual control system (RCCS) allows multiple remote individuals to control a single controller at a distance, such that it only takes 1 user to assert a locking (or unlocking) signal, but requires that there are no outstanding users in order to reverse the control. In other words, it requires a consensus of all users who asserted the first control state to issue a de-asserting signal. It is different from switches, locks, or remote telecommunication operation devices that are toggled without consensus logic. In existing systems, any authorized user is able to toggle a lock. It is also different from lock-out tag-out systems that require physical locks to be applied in person.
